(19) United States
(12) Patent Application Publication
(10) Pub. No.: US 2013/0096529 A1
(43) Pub. Date: Apr. 18, 2013

(54) TUBE SET INSERTION APPARATUS

(71) Applicant: Ala Moradian, St. Louis, MO (US)

(72) Inventor: Ala Moradian, St. Louis, MO (US)

(21) Appl. No.: 13/275,621

(22) Filed: Oct. 18, 2011

(51) Int. Cl. A61J 1/20

(52) U.S. Cl. 604/414; 604/403

(57) ABSTRACT

A tube set insertion apparatus for connection to a bottle of saline solution, comprising a flange adapted to connect to the bottle at an opening in the bottle, a plurality of holding members positioned relative to one another to form a channel and to align a drip chamber disposed therein with the opening, each of the plurality of holding members connected to a corresponding one of a rack and a pinion, and a plurality of levers, each lever adapted to rotate about a corresponding pivot, and each lever connected to a corresponding other of the rack and the pinion. Each pinion positioned relative to a corresponding one of the racks such that rotation of the lever about its pivot causes a bottle, when disposed in the channel, to move toward the opening.

### FIELD OF INVENTION

The present invention relates to methods and apparatus for facilitating fluid connection of a surgical tube set to a bottle of saline solution.

### BACKGROUND OF THE INVENTION

During the course of an ophthalmic surgery, saline solution is delivered to an eye through a tube set to maintain suitable eye pressure. The solution is provided in a bottle. Conventionally, to fluidly connect to a bottle of saline solution, at start of a surgery or intraoperatively when a new bottle of saline solution is needed, the surgeon removes an aluminum foil cover from the bottle and manually inserts the sharp tip of the tube set (commonly referred to as a bottle spike) through the bottle's lid. Insertion of the spike typically requires using both hands to hold the bottle and insert the spike, and considerable force to puncture the lid.

### SUMMARY

Aspects of the present invention are directed to an apparatus for facilitating connection of a tube set to a bottle of saline solution by mechanically assisting insertion of a bottle spike into a bottle of saline. The insertion may be achieved with the bottle hanging upside down (such as from a pole) using only a single hand.

An aspect of the invention is directed to a tube set insertion apparatus for connection to a bottle of saline solution. The apparatus comprises a flange adapted to connect to the bottle at an opening in the bottle, a plurality of holding members positioned relative to one another to form a channel and to align a drip chamber disposed therein with the opening, each of the plurality of holding members connected to a corresponding one of a rack and a pinion, and a plurality of levers, each lever adapted to rotate about a corresponding pivot, and each lever connected to a corresponding other of the rack and the pinion. Each pinion is positioned relative to a corresponding one of the racks such that rotation of the lever about its pivot causes a bottle, when disposed in the channel, to move toward the opening.

In some embodiments, rotation of the plurality of levers about their corresponding pivots causes the plurality of holding members to move toward the opening. In some embodiments, each lever is coupled to the flange such that the pivots are fixed relative to the flange.

The apparatus may be in a combination with the tube set comprising tubing, the drip chamber fluidly coupled to the tubing, and a bottle spike operatively coupled to the drip chamber, the tube set being disposed in the channel such that rotation of the plurality of levers about their pivots causes the bottle spike to move into the opening. The apparatus and the tube set may be connected together by a friction fit.

In some embodiments, the flange comprises a plurality of resilient arms adapted to achieve an open configuration to receive a neck of the bottle, and a closed position in which detachment of the bottle from the apparatus is prevented by interference with the plurality of arms. In some embodiments, the flange is threaded so as to be capable of attaching to a bottle by a screw-type connection.

In some embodiments, each of the plurality of holding members is rigidly connected to the flange, and a first of the plurality of levers is adapted to rotate about a first of the pivots, and a second of the plurality of levers is adapted to rotate about a second of the pivots. In some such embodiments, the apparatus further comprises a connecting rod connected to the first pivot and the second pivot, and attachment means for attaching the connecting rod to a drip chamber of a tube set, whereby rotation of the plurality of levers about their pivot points causes a bottle, when attached to the connecting rod, to move toward the opening.

In some embodiments, the flange comprises a plurality of resilient arms adapted to achieve an open configuration to receive a neck of the bottle, and a closed position in which detachment of the bottle from the apparatus is prevented by interference with the plurality of arms. In some embodiments, the flange is threaded so as to be capable of attaching to a bottle by a screw-type connection.

The connection means may comprise at least one of a screw, a snap, a pin or an adhesive.

The apparatus may be in a combination with the tube set comprising tubing, the drip chamber fluidly coupled to the tubing, and a bottle spike operatively coupled to the drip chamber, the tube set being disposed in the channel such that rotation of the levers about their pivots causes the bottle spike to move into the opening.

The apparatus and the tube set may be connected together by a friction fit.

The apparatus may comprise a tube set priming structure comprising a first protrusion and a second protrusion, the first protrusion and the second protrusion positioned and shaped to squeeze the drip chamber when the drip chamber is located in the channel and the plurality of levers is squeezed toward one another.

### BRIEF DESCRIPTION OF THE DRAWINGS

Illustrative, non-limiting embodiments of the present invention will be described by way of example with reference to the accompanying drawings, in which the same reference number is used to designate the same or similar components in different figures, and in which:

FIG. 1A is a schematic cross-sectional illustration of an example of a tube set insertion apparatus for fluidly connecting a tube set to a bottle of saline solution in accordance with aspects of the present invention;

FIG. 1B is a schematic cross-sectional illustration of the tube set insertion apparatus of FIG. 1 being connected to the bottle of saline solution;

FIG. 1C is a schematic cross-sectional illustration of the tube set insertion apparatus of FIG. 1 after it has been connected to the bottle of saline solution;

FIG. 1D is a schematic cross-sectional illustration of the tube set insertion apparatus of FIG. 1 after it has been actuated to pierce the lid of the bottle of saline solution;

FIG. 2A is a schematic cross-sectional illustration of another example of a tube set insertion apparatus for fluidly connecting a tube set to a bottle of saline solution in accordance with aspects of the present invention;

FIG. 2B is a schematic cross-sectional illustration of the tube set insertion apparatus of FIG. 1 being connected to the bottle of saline solution;

FIG. 2C is a schematic cross-sectional illustration of the tube set insertion apparatus of FIG. 1 after it has been connected to the bottle of saline solution; and

FIG. 2D is a schematic cross-sectional illustration of the tube set insertion apparatus of FIG. 1 after it has been actuated to pierce the lid of the bottle of saline solution.

### DETAILED DESCRIPTION

Aspects of the present invention are directed towards methods and apparatus for facilitating fluidly connecting a tube set to a bottle of saline solution thereby adding consistency and ease to the connection process.

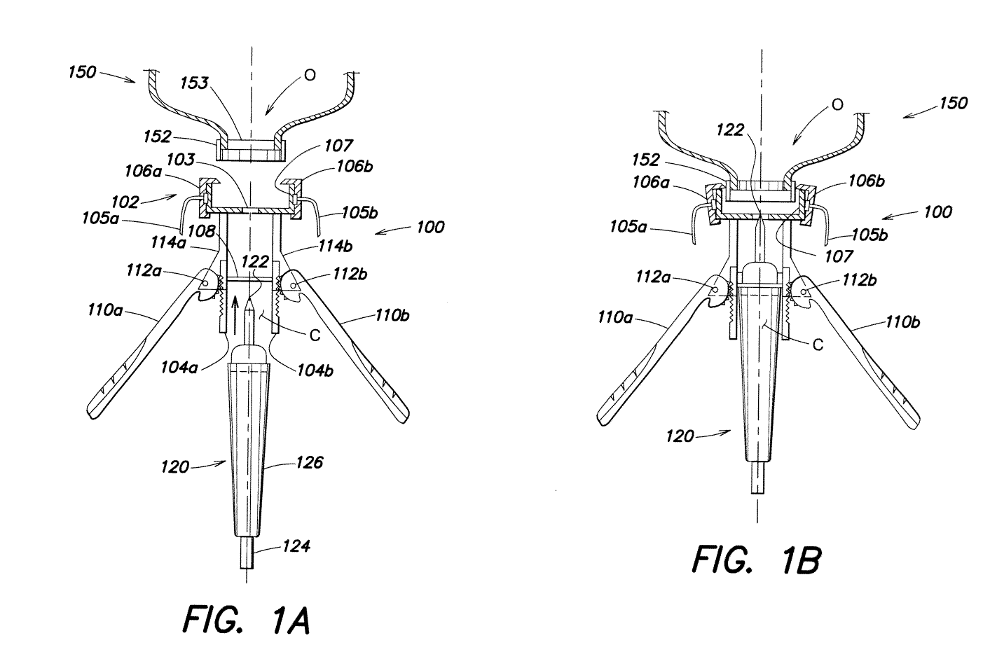

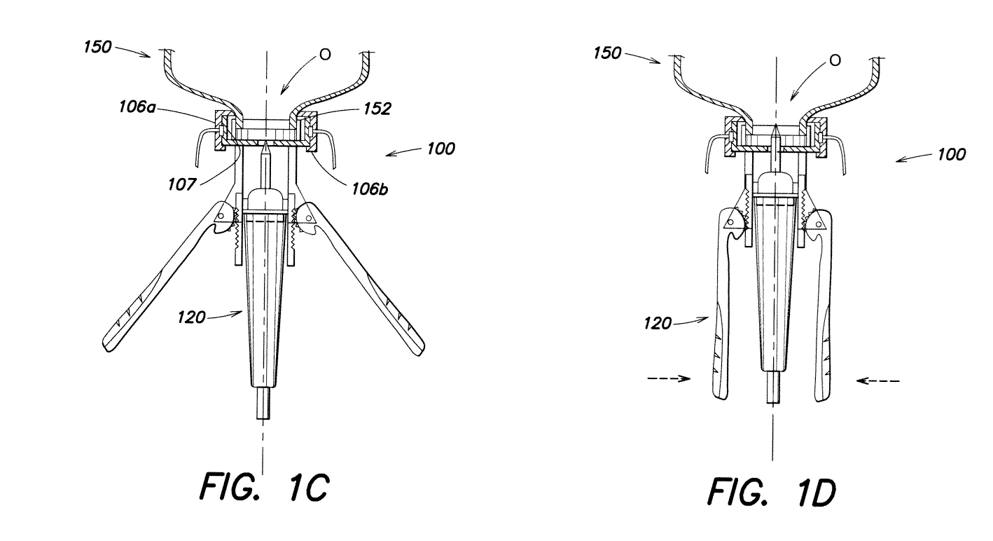

FIG. 1A is a schematic cross-sectional illustration of an example of a tube set insertion apparatus 100 for fluidly connecting a tube set to a bottle of saline solution in accordance with aspects of the present invention. Apparatus 100 comprises a flange 102, a plurality of holding members 104a and 104b, and a plurality of levers 110a and 110b. The apparatus facilitates operative coupling of a bottle of a saline solution 150 with a tube set 120 which typically comprises tubing 124, a drip chamber 126 fluidly coupled to the tubing, and a bottle spike 122 fluidly coupled to the drip chamber.

Flange 102 is adapted to connect to the bottle at an opening O in bottle 150. Flange 102 is comprised two resilient arms 106a and 106b, and a rigid element 107. As shown in FIG. 1B, the two resilient arms 106a and 106b can be flexed using handles 105a and 105b, respectively, to achieve an open position. When the open position is achieved, a bottle neck 152 including opening O can received into rigid element 107. As shown in FIG. 1C, when neck 152 is in fixed element 107, the resilient arms are relaxed to a position where detachment of the bottle from the apparatus is prevented by interference of resilient arms 106a and 106b with neck 152.

Referring again to FIG. 1A, although flange 102 is illustrated as providing an interference-type connection, flange 102 and bottle neck 152 may have any suitable configurations to provide a connection therebetween. For example, the flange and bottle may be threaded to form a screw-type connection therebetween or be sized and shaped to have a frictional fit therebetween. Also, although the flange is illustrated with two resilient arms, one or more such features may be used to provide a connection between apparatus 100 and bottle 150.

Plurality of holding members 104a and 104b are positioned relative to one another to form a channel C and to hold drip chamber 126. The holding members also align the drip chamber with the opening 103 in the flange and opening O such that, upon actuation of the apparatus by movement of levers 110a and 110b, spike 122 of the tube set enters opening O piercing any lid 153 covering opening O. Each of the plurality of holding members 104 is connected to a corresponding one of a rack and a pinion. As shown, in some embodiments, each holding member and the corresponding one of the rack and the pinion are integrated as a single part; however, any suitable form of connection between a rack or a pinion and the holding member may be used. The holding members 104a and 104b are rigidly positioned relative to one another (e.g., by a connecting rod 108).

Each of the plurality of levers 110 is adapted to rotate about a corresponding pivot 112, and each lever is connected to a corresponding other of the rack and the pinion (e.g., if a holding member has a rack, the corresponding lever has a pinion; and if the holding member has a pinion, the corresponding lever has a rack). Each pinion has its pivot positioned relative to a corresponding one of the racks such that rotation of a lever 110 about its pivot 112 causes the corresponding holding member 104 to move toward the opening O. Axial motion of the holding members 104 and of a drip chamber held in the channel is controlled by levers 110 through the rack and pinion arrangement.

Although in the illustrated embodiment the actuation apparatus is illustrated as a lever operating the rack and pinion in a linear manner, in other embodiments, the lever may operate the rack and pinion in the manner of a worm drive.

In FIGS. 1B-1D, the apparatus 100 is in a combination with tube set 120, the tube set being disposed in the channel C such that rotation of levers 110 about their pivots 112 causes bottle spike 122 to move into opening O. In the illustrated embodiment, the drip chamber and channel are sized and shaped to achieve a frictional fit therebetween; however, any connection between the holding members and the tube set that permits movement of the bottle spike to enter the enter the opening O upon actuation of the holding members by the lever (as described above) may be used.

In the illustrated embodiment, a positioning element 114a positions pivot 112a and holding member 104a relative to one another; and similarly a positioning element 114b positions pivot 112b and holding member 104b relative to one another. A positioning element 114 need not have any particular configuration, provided it positions the lever and the holding element relative to one another to permit axial motion of the holding members 104 to be controlled by levers 110 using a rack and pinion arrangement. In the illustrated embodiment, positioning elements 114 position pivots 112 and holding members 104 relative to flange such that, as shown in FIG. 1D, actuation of the levers 110 causes the bottle spike 122 to enter the opening O and puncture any covering of opening O (e.g., lid 153) in its path. While, in the illustrated embodiment, a single element (e.g., positioning element 114a or 114b) operates, both, to position a lever and a holding element relative to one another and to position pivots and holding elements relative to flange, a single positioning element need not perform these operations, rather two or more elements may be used. Also while, in the illustrated embodiment, the lever is coupled to the flange such that the pivots are fixed relative to the flange, such a configuration is not necessary.

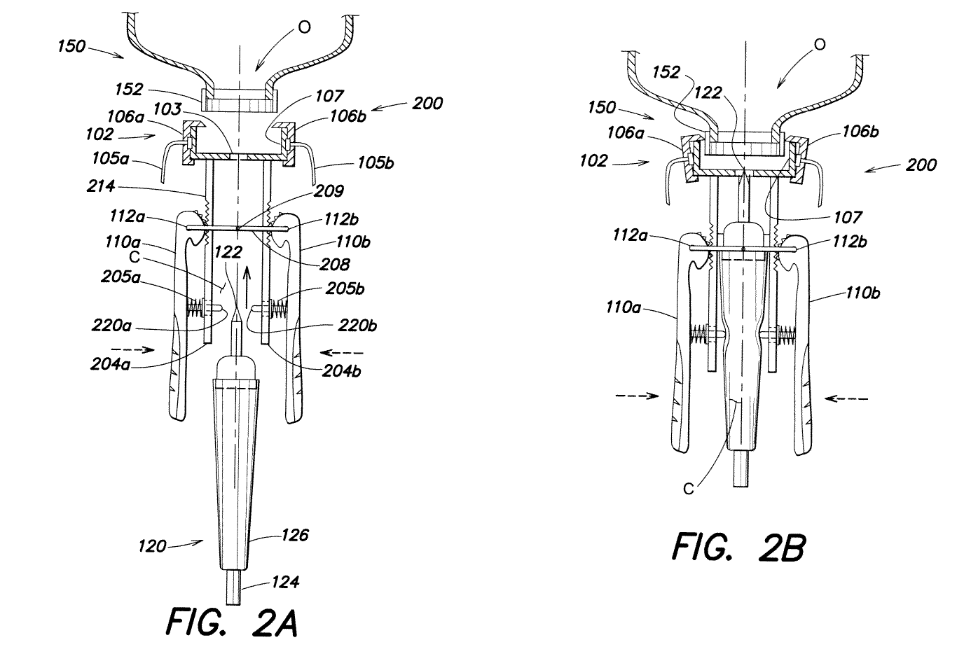

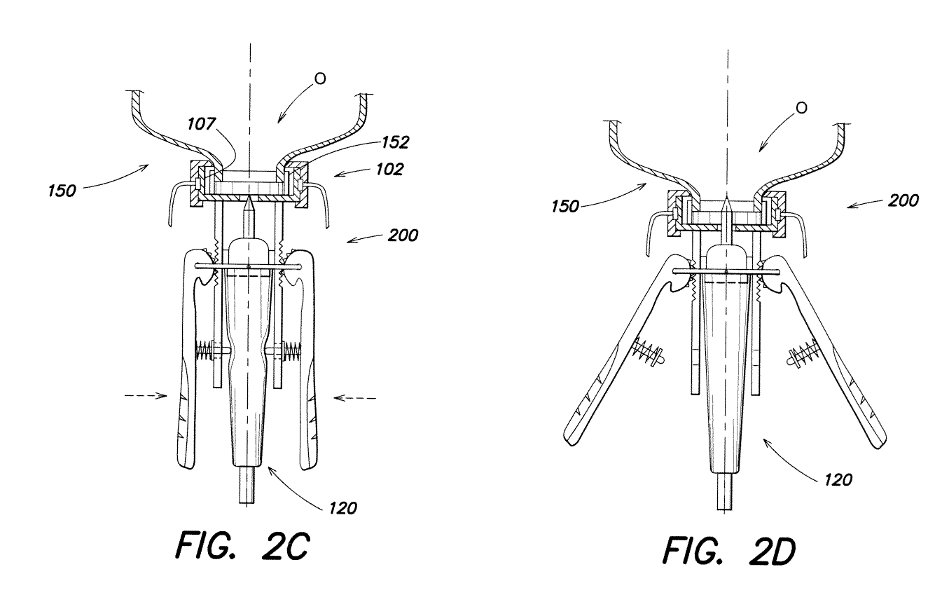

FIG. 2A is a schematic cross-sectional illustration of another example of a tube set insertion apparatus 200 for fluidly connecting a tube set to a bottle of saline solution 150 in accordance with aspects of the present invention. Apparatus 200 comprises a flange 102, a plurality of holding members 204a and 204b, and a plurality of levers 110a and 110b. The apparatus facilitates operative coupling of bottle of saline solution 150 with a tube set 120 which typically comprises tubing 124, the drip chamber 126 fluidly coupled to the tubing, and a bottle spike 122 fluidly coupled to the drip chamber.

Flange 102 is adapted to connect to the bottle at an opening O in bottle 150. Flange 102 is comprised of two resilient arms 106a and 106b, and rigid element 107. As shown in FIG. 2B, the two resilient arms 106a and 106b can be flexed out of the way to an open position. When the open position is achieved, bottle neck 152 including opening O can be received into rigid element 107. As shown in FIG. 2C, when the neck 152 is in fixed element 107, the resilient arms can be relaxed to a position where detachment of the bottle from the apparatus is prevented by interference of the resilient arms 106 with neck 152.

Although the flange 102 is illustrated as providing an interference-type connection, flange 102 and bottle neck 152 may have any suitable configurations to provide a connection therebetween. For example, the flange and bottle may be threaded to form a screw-type connection therebetween or be sized and shaped to have a frictional fit therebetween. Also, although the flange is illustrated with two resilient arms, one or more such features may be used to provide a connection.

Referring again to FIG. 2A, plurality of holding members 204a and 204b is rigidly connected to the flange 102. Holding members 204 are positioned relative to one another to form a channel C and to align a drip chamber 126 of a tube set 120 disposed therein opening 103 in the flange and opening O such that, upon actuation of the apparatus, spike 122 of the tube set enters opening O. Each of the plurality of holding members 204 is connected to a corresponding one of a rack and a pinion. In some embodiments, each holding member and the one of the rack and the pinion are integrated as a single part; however, any suitable form of connection between rack and the pinion holding member may be used.

Each of the plurality of levers 110 is connected to a corresponding other of the rack and the pinion (e.g., if the holding member has a rack, the corresponding lever has a pinion; and if the holding member has a pinion, the corresponding lever has a rack). A first 110a of the plurality of levers is adapted to rotate about a first pivot 112a, and a second 110b of the plurality of levers is adapted to rotate about a second pivot 112b.

A connecting rod 208 is connected to first pivot 112a and the second pivot 112b. An attachment means 209 is capable of attaching the connecting rod to a drip chamber of a tube set. The attachment means may be any suitable apparatus for attaching the connecting rod to the drip chamber such that the drip chamber moves with the connection rod when it is moved in the manner described below. For example, the connection means may comprise a screw, snap, a pin or an adhesive. Bottle 150 may have a corresponding second connection means to allow connection to connection means 209.

Rotation of the pair of levers 110 about pivot points 112 causes the teeth in the pinions to contact the holding members further up the rack (in the orientation illustrated in FIG. 2D) thereby resulting in pivots 112, connecting rod 208 moving upward along the rack, and because the pivots are attached to the bottle by the connecting rod, causing bottle 150 attached to connecting rod 208 to move toward opening O.

As shown in FIGS. 2B-2D, the apparatus 200 is in a combination with tube set 120, the tube set being disposed in the channel C such that rotation of the levers 110 about their pivots 112 causes the bottle spike 122 to move into the opening O. In the illustrated embodiment, the drip chamber and channel are sized and shaped to achieve a frictional fit therebetween; however, any connection between the holding members and the tube set that permits movement of the bottle spike to enter the enter the opening O (as described above) may be used.

Optionally, projections 220a and 220b may be included to permit priming of the tube set with saline solution. The projections positioned and shaped to extend into channel C when the levers are squeezed toward one another, thereby squeezing the drip chamber. As a result, a negative pressure is achieved in the drip chamber as the drip chamber achieves its uncompressed state after levers 110 are lifted to move the bottle spike into opening O, which results in saline solution being drawn into the drip chamber to prime the tube set with saline solution from bottle 150 after the spike enters opening O. It will be appreciated that the construction of the drip chamber is selected such that the resiliency of the drip chamber causes the drip chamber to return to its uncompressed state a sufficient time after the levers are lifted (as shown in FIG. 2D) and spike 122 enters the opening O. Projections 220a and 220b may be connected to levers 110a and 110b, respectively. Springs 205a and 205b may be included to bias the levers away from the holding members and to withdraw the projections from channel C.

Having thus described the inventive concepts and a number of exemplary embodiments, it will be apparent to those skilled in the art that the invention may be implemented in various ways, and that modifications and improvements will readily occur to such persons. Thus, the embodiments are not intended to be limiting and presented by way of example only. The invention is limited only as required by the following claims and equivalents thereto.

1. A tube set insertion apparatus for connection to a bottle of saline solution, comprising:
a flange adapted to connect to the bottle at an opening in the bottle;
a plurality of holding members positioned relative to one another to form a channel and to align a drip chamber disposed therein with the opening, each of the plurality of holding members connected to a corresponding one of a rack and a pinion; and
a plurality of levers, each lever adapted to rotate about a corresponding pivot, and each lever connected to a corresponding other of the rack and the pinion,
each pinion positioned relative to a corresponding one of the racks such that rotation of the lever about its pivot causes a bottle when disposed in the channel to move toward the opening.

2. The apparatus of claim 1, wherein rotation of the plurality of levers about their corresponding pivots causes the plurality of holding members to move toward the opening.

3. The apparatus of claim 2, wherein each lever is coupled to the flange such that the pivots are fixed relative to the flange.

4. The apparatus of claim 2, in a combination with the tube set comprising tubing, the drip chamber fluidly coupled to the tubing, and a bottle spike operatively coupled to the drip chamber,
the tube set disposed in the channel such that rotation of the plurality of levers about their pivots causes the bottle spike to move into the opening.

5. The apparatus of claim 4, wherein the apparatus and the tube set are connected together by a friction fit.

6. The apparatus of claim 2, wherein the flange comprises a plurality of resilient arms adapted to achieve an open configuration to receive a neck of the bottle, and a closed position in which detachment of the bottle from the apparatus is prevented by interference with the plurality of arms.

7. The apparatus of claim 2, wherein the flange is threaded so as to be capable of attaching to a bottle by a screw-type connection.

8. The apparatus of claim 1, wherein each of the plurality of holding members is rigidly connected to the flange, and a first of the plurality of levers is adapted to rotate about a first of the pivots, and a second of the plurality of levers is adapted to rotate about a second of the pivots, the apparatus further comprising:
a connecting rod connected to the first pivot and the second pivot;
attachment means for attaching the connecting rod to a drip chamber of a tube set,
whereby rotation of the plurality of levers about their pivot points causes a bottle, when attached to the connecting rod, to move toward the opening.

9. The apparatus of claim 8, wherein the flange comprises a plurality of resilient arms adapted to achieve an open configuration to receive a neck of the bottle, and a closed position in which detachment of the bottle from the apparatus is prevented by interference with the plurality of arms.

10. The apparatus of claim 8, wherein the flange is threaded so as to be capable of attaching to a bottle by a screw-type connection.

11. The apparatus of claim 8, wherein the connection means comprises at least one of a screw, a snap, a pin or an adhesive.

12. The apparatus of claim 8, in a combination with the tube set comprising tubing, the drip chamber fluidly coupled to the tubing, and a bottle spike operatively coupled to the drip chamber,
the tube set disposed in the channel such that rotation of the levers about their pivots causes the bottle spike to move into the opening.

13. The apparatus of claim 8, wherein the apparatus and the tube set are connected together by a friction fit.

14. The apparatus of claim 8, further comprising a tube set priming structure comprising a first protrusion and a second protrusion, the first protrusion and the second protrusion positioned and shaped to squeeze the drip chamber when the drip chamber is located in the channel and the plurality of levers is squeezed toward one another.
